(19) United States
(12) Patent Application Publication
(10) Pub. No.: US 2014/0294530 A1
(43) Pub. Date: Oct. 2, 2014

(54) APPARATUS AND METHOD FOR CHAMFERING A WORKPIECE

(71) Applicant: Liebherr-Verzahntechnik GmbH, Kempten (DE)

(72) Inventors: Hansjoerg Geiser, Wiggensbach (DE); Oliver Winkel, Kempten (DE); Andreas Heidemann, Kempten (DE)

(21) Appl. No.: 14/223,452

(22) Filed: Mar. 24, 2014

(30) Foreign Application Priority Data
Mar. 28, 2013 (DE) 10 2013 005 559.8
Sep. 13, 2013 (DE) 10 2013 015 240.2

(51) Int. Cl. B23F 19/10

(52) U.S. Cl. CPC B23F 19/102
USPC 409/8

(57) ABSTRACT

An apparatus for chamfering a toothed workpiece with at least one rotatably mounted workpiece spindle and with at least one machining unit with at least one machining head for chamfering a workpiece clamped in a spindle, wherein the machining unit with at least one machining head exclusively comprises chamfer cutters which permit machining of the workpiece on two different sides of the workpiece, in particular Chamfer Cut units, and that the machining unit with at least one machining head comprises a device for loading chamfer cutters and/or for centering chamfer cutters relative to the position of the toothing on the workpiece.

### CROSS REFERENCE TO RELATED APPLICATIONS

This application claims priority to German Patent Application No. 10 2013 005 559.8, entitled “Apparatus and Method for Chamfering a Workpiece,” filed Mar. 28, 2013, and also claims priority to German Patent Application No. 10 2013 015 240.2, entitled “Apparatus and Method for Chamfering a Workpiece,” filed Sep. 13, 2013, both of which are hereby incorporated by reference in their entirety for all purposes.

### TECHNICAL FIELD

The present disclosure relates to an apparatus and a method for chamfering an externally and/or internally toothed workpiece.

### BACKGROUND AND SUMMARY

Apparatuses for chamfering workpieces are known for example in gear milling machines and have the function to remove sharp edges or burrs obtained during the gear milling operation at the end faces by chamfering.

The tool employed usually comprises a tool mandrel on which both one or more milling cutters for producing the toothing and at least one chamfer cutter for chamfering at least one of the tooth edges produced are mounted.

It is not possible to actuate the milling and chamfer cutting operations independent of each other, whereby it is always only possible to carry out either a milling or a chamfer cutting operation of the workpiece.

It is problematic here that this operation leads to an extension of the machining time for the workpiece, since the chamfering process must take place subsequent to the milling process.

It therefore is the object of the present disclosure to develop an apparatus for chamfering a workpiece in an advantageous way, in particular to the effect that the total time for the gear cutting process is not prolonged by the chamfering process, and a chamfering process can be used between two milling processes or between a roughing process and a finishing process.

Furthermore, it is the object of the present disclosure to not only couple the chamfering process with a gear milling process, but to provide for combining this type of chamfering with further tooth-producing or tooth-cutting processes, such as e.g. shaping or scraping of toothings, in which no tool mandrel is present for accommodating a chamfer cutter.

According to the present disclosure, this object is solved by an apparatus with at least one rotatably mounted workpiece spindle and with at least one machining unit with at least one machining head for chamfering a workpiece clamped in a spindle, wherein the machining unit with at least one machining head exclusively comprises chamfer cutters, herein referred to as Chamfer Cut units, which permit machining of the workpiece on two different sides of the workpiece.

Since the workpiece is supplied to the apparatus described here from a unit or a workpiece table of a previous operation, in particular gear hobbing, it is necessary that the machining unit with at least one machining head comprise an apparatus for loading chamfer cutters and/or for centering chamfer cutters relative to the position of the toothing on the workpiece. When handing over the workpiece from the previous operation to the apparatus for chamfering, the information with respect to tooth gap and tooth center gets lost and further machining without a new adjustment would not be possible.

An apparatus designed in this way advantageously provides for carrying out a separate chamfer cutting operation at a workpiece, without pauses having to be made during the chamfer cutting operation due to another machining step which likewise is carried out by the machining unit.

This provides for carrying out the chamfering operation on two different sides of the workpiece at the same time, whereby advantageously the machining time of the workpiece is reduced. It also becomes possible to alternatively produce either clean front edges, i.e. free from microburrs, or clean flank edges.

For example, when during the first operation gear hobbing is effected and chamfering consists of a chamfering operation with corresponding Chamfer Cut units, there is enough time for centering and loading parallel to gear hobbing before the actual chamfering operation, since the machining step of chamfering is much shorter than the gear hobbing operation.

Loading designates the finding of the tooth gap in the workpiece with respect to the tooth of the tool, i.e. the finding of the starting position. Centering designates the exact positioning of the tool in the tooth gap. This can be effected for example via a so-called C-axis offset, i.e. the uniform rolling coupling of workpiece and tool is interrupted briefly, and by slowing down and accelerating one axis of rotation each, the tool is properly positioned relative to the workpiece, before the rolling coupling is closed again, in order to be able to start the machining process of chamfering for example by chamfer cutting. Both machining processes occur with the same control quality, i.e. with the same quality at the same concentricity (rolling coupling).

The adjustment of the machining unit advantageously is simplified or at least partly automated thereby.

In one example embodiment it is conceivable that the machining unit with at least one machining head comprises at least two separately actuatable Chamfer Cut units, wherein separate drives, in particular separately actuatable drives, are provided, for each Chamfer Cut unit.

Such division of the machining unit into at least two separate Chamfer Cut units, provides for machining the workpiece in parallel at more than one machining point or also several workpieces in parallel by means of the machining unit with at least one machining head. The machining time thereby is shortened advantageously.

In a further example embodiment it is conceivable that the apparatus is arranged in a suspended position.

In contrast to a vertical arrangement of a machining unit with at least one machining head it can thus be avoided that the chips obtained during the machining operation penetrate into a kinematic system extending in the bottom region of the machining unit and impair the freedom of movement of the machining unit.

In another example embodiment it is also conceivable that the apparatus is arranged inside a gear cutting machine.

In a further example embodiment it is also conceivable that the apparatus is formed as an independent chamfering machine for chamfering toothed workpieces. The same can be coupled with an adjacent gear cutting machine, e.g., by automation and thus a rather high degree of automation of the machining process can be ensured.

A configuration as an independent deburring cell also would be possible in accordance with the present disclosure.

In another example embodiment it is conceivable that the apparatus is coupled with an adjacent gear cutting machine via a transport device.

In a further example embodiment it is conceivable that the apparatus is arranged inside a toothed workpiece for chamfering internal toothings and/or that the apparatus comprises an automatic tool changer.

With larger internal toothings, the apparatus can be arranged inside the toothed workpiece on a fixed stand in the center of the machine table or on a support above the machine table and thus serve for the chamfer machining of internal toothings.

The present disclosure furthermore is directed to a method for chamfering a workpiece by means of an apparatus as described above, with the corresponding advantages mentioned with respect to the apparatus.

In one example embodiment it is conceivable that chamfering is carried out between at least two milling steps and/or between at least one roughing step and at least one finishing step.

The milling steps for example also can be roughing steps.

In one configuration of the machining unit, in particular of the Chamfer Cut unit, in the gear cutting machine different designs of workpiece tables are required. Since higher powers are required during gear hobbing, the corresponding workpiece table requires a stronger drive motor with higher torques than the workpiece table for the machining unit for chamfering. The workpiece table for chamfering advantageously can be designed smaller, wherein it only must carry a comparatively weaker motor and a controller with a smaller power module.

Further details and advantages of the present disclosure will now be explained in detail with reference to example embodiments illustrated in the Figures.

### BRIEF DESCRIPTION OF THE FIGURES

FIG. 1 shows an apparatus with a Chamfer Cut unit.

FIG. 2 shows an apparatus with two Chamfer Cut units.

FIG. 3 shows a suspended arrangement of the apparatus.

FIGS. 4a-c show a schematic representation of the machining of the workpiece on two different sides of the workpiece.

FIG. 5 shows a machining unit with loading sensor.

FIG. 6 shows an apparatus with rough deburring wheel.

FIG. 7 shows an example method of operating an apparatus with Chamfer Cut units.

### DETAILED DESCRIPTION

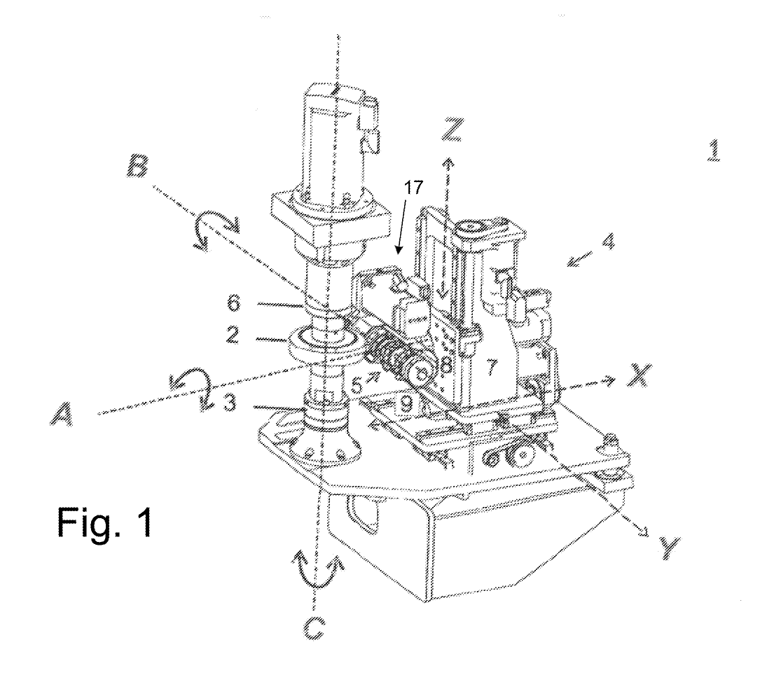

The example embodiment shown in FIG. 1 represents an apparatus 1 for chamfering a workpiece 2, wherein the workpiece 2 can be a gear wheel, for example. The workpiece 2 is rotatably mounted on a workpiece spindle 3 about an axis C.

In the illustrated example embodiment, a machining unit 4 comprises a machining head 17 with two Chamfer Cut units 5 coupled with each other. For rotating the workpiece 2, the workpiece spindle 3 includes a spindle 6. Chamfer Cut units 5 are configured for cutting chamfers, or chamfering a workpiece.

In the illustrated example embodiment, the coupled Chamfer Cut units 5 are rotatably mounted directly on the machining unit 4 about two axes A, B. The entire machining unit 4 is designed to move the coupled Chamfer Cut units 5 along the linear axes X, Y and Z. For this purpose, corresponding travel carriages 7, 8 and 9 are arranged at the machining unit 4.

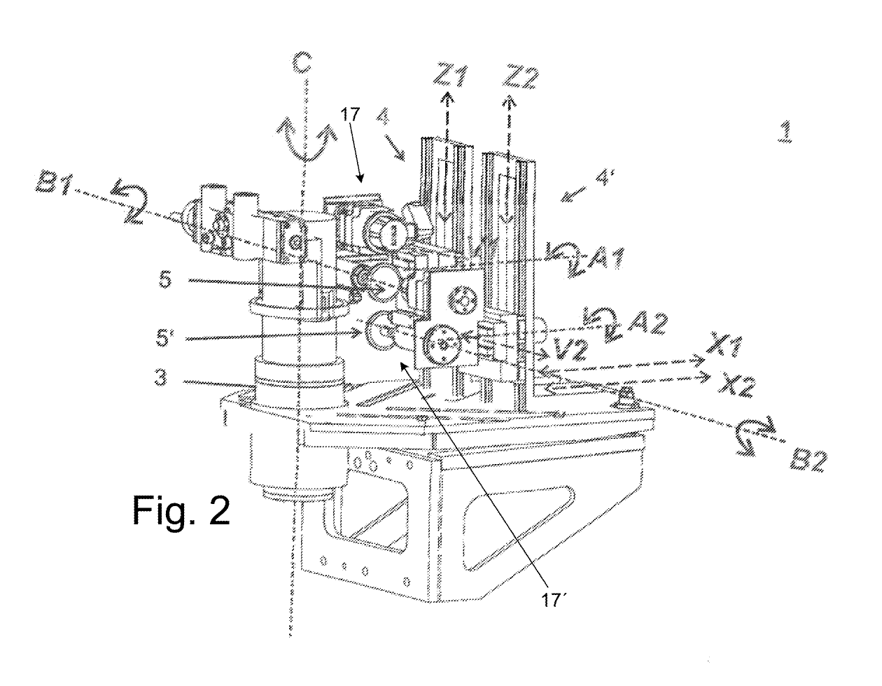

The example embodiment shown in FIG. 2 includes two machining heads 17, 17′ with two independently actuatable Chamfer Cut units 5, 5′, which are independently provided at the machining units 4 and 4′.

Except for the unchanged workpiece axis of rotation C, the number of the degrees of freedom (A1, A2, B1, B2, X1, X2, V1, V2, Z1, Z2) of the apparatus 1 of FIG. 2 thus is doubled. Due to the independent mounting, the two Chamfer Cut units 5, 5′ in the example embodiment of FIG. 2 can be actuated such that they act on different machining points of one and the same workpiece 2 at the same time and thus machine the same in parallel. In alternative embodiments it likewise is conceivable that the two Chamfer Cut units 5, 5′ act on different toothings arranged one above the other or beside each other on one or more workpieces 2 in parallel, as it can occur, e.g., in shafts with several toothings or in the case of multiple machining

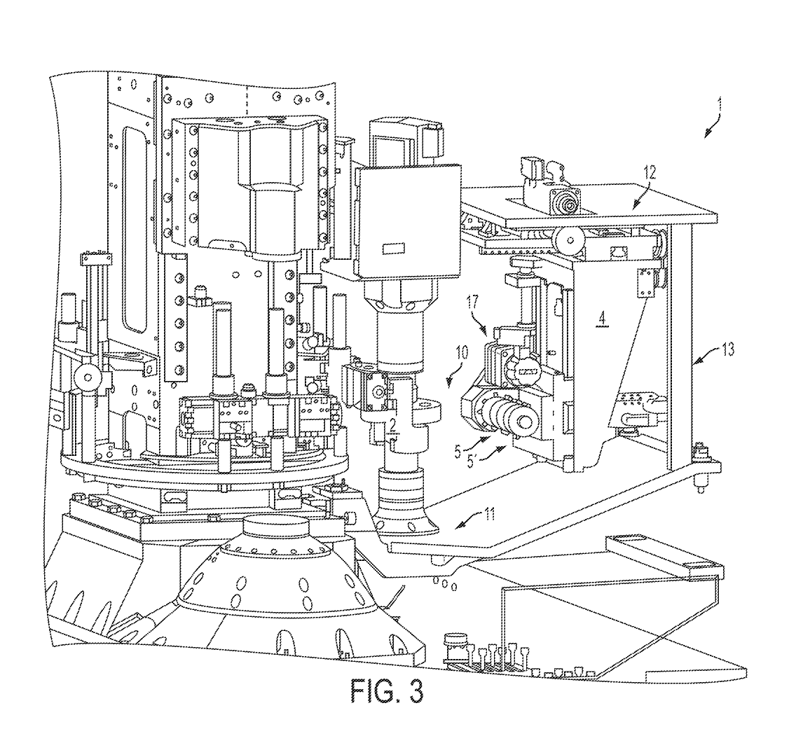

The example embodiment represented in FIG. 3 shows an embodiment in which an apparatus 1 with a machining head 17 and two directly coupled Chamfer Cut units 5, 5′ is arranged in suspended position. There is provided a holding device 13 in a region remote from the workpiece 2, on which the machining unit 4 is mounted in suspended position. The chips obtained during machining in the region 10, which after separation from the workpiece 2 fall into the region 11, thus cannot get in conflict with the kinematic system of the machining unit 4, which is provided in a kinematic region 12 arranged above the region 11.

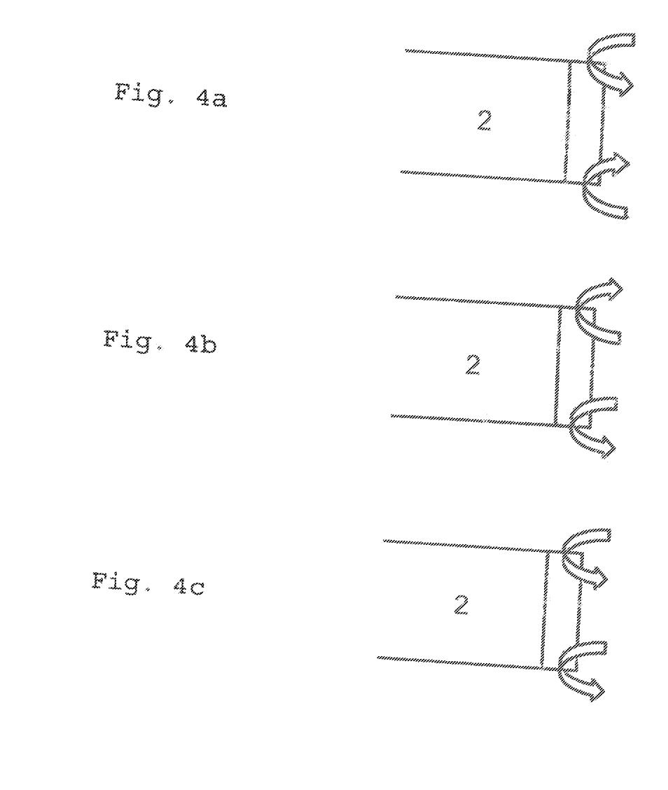

FIGS. 4a to 4c show different operating modes of the chamfer cutter or the chamfer cutters of the apparatus 1 according to the present disclosure.

In FIG. 4a an arrangement of two chamfer cutters is shown by means of arrows, in which a change in the direction of rotation of the chamfer cutter takes place. There can be used two identical cutters at the same time, wherein the same are arranged offset by 180°. Microburrs at the workpiece 2 can be obtained in the flanks, but not at the front edges, so that a clean front edge is given after chamfering. The microburrs obtained at the flanks subsequently can be removed with a rough deburring wheel.

In FIG. 4b a chamfer cutter arrangement is shown by means of arrows, in which likewise a change in the direction of rotation of the chamfer cutter occurs, but where an individual cutter can be used. Microburrs at the workpiece 2 here can be obtained at the front edges, but not in the flanks. Due to their small-size formation, these microburrs can be destroyed during a subsequent heat treatment of the workpiece 2.

FIG. 4c shows a similar arrangement of the chamfer cutters, as it is shown in FIG. 4a, in which however no change in the direction of rotation of a tool spindle 6 and/or table is required. The microburrs obtained in the flanks during the machining of the workpiece 2 subsequently are removed with a rough deburring wheel.

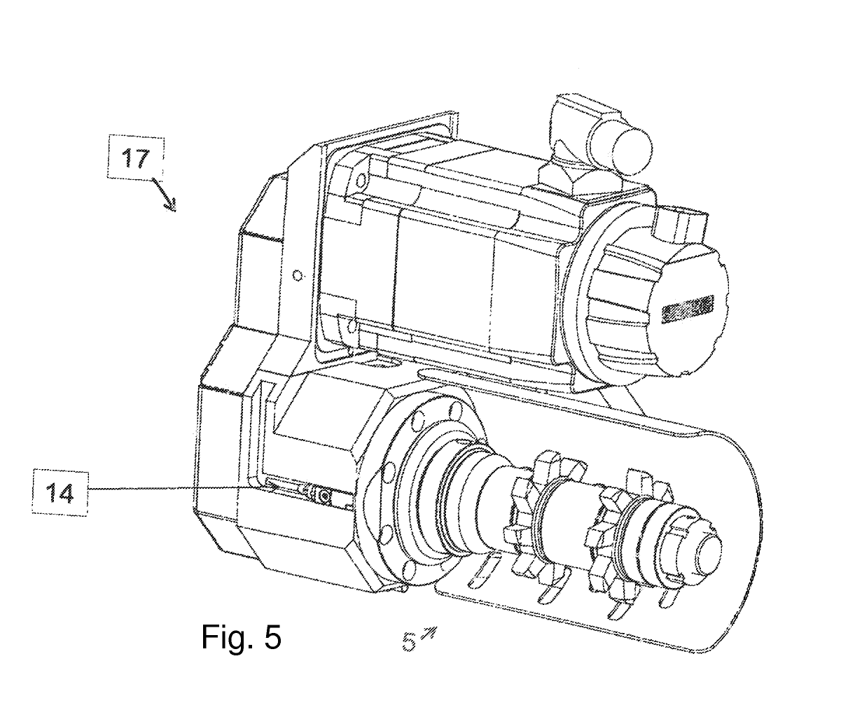

FIG. 5 shows a detailed segment of an example embodiment of the apparatus 1 with a loading sensor 14 as device for loading the chamfer cutter and/or for centering the chamfer cutter relative to the position of the toothing on the workpiece. The loading sensor 14 is provided in the machining head 17 in the region of the Chamfer Cut unit 5.

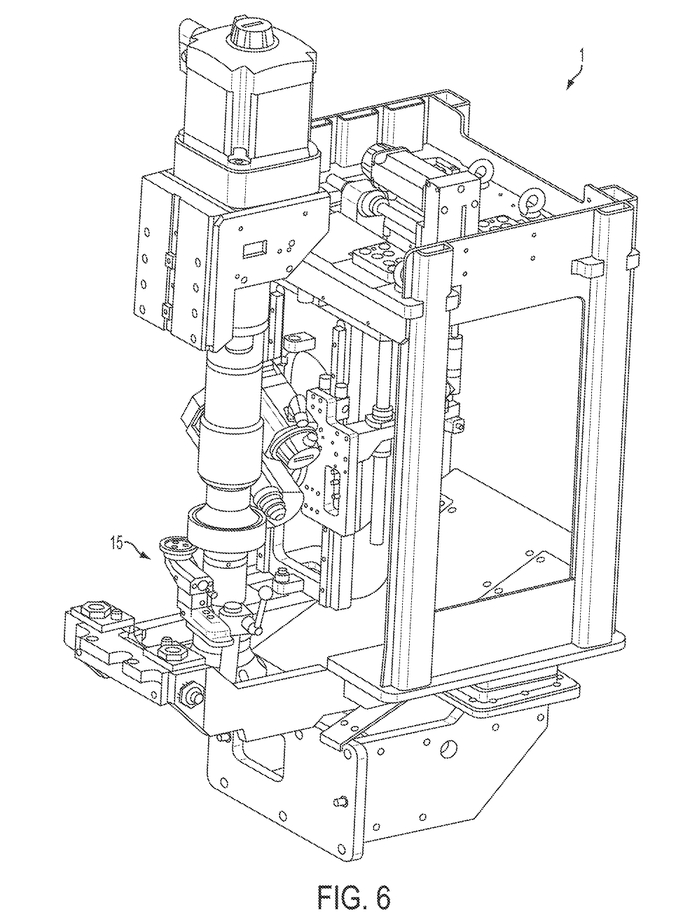

In the embodiment shown in FIG. 6 the apparatus 1 additionally comprises a rough deburring wheel 15. The rough deburring wheel 15 is designed for removing coarse burrs which are obtained due to the milling method.

In one example, the apparatus of FIGS. 1-6 is arranged inside a gear cutting machine. In another example, the apparatus is formed as an independent chamfering machine. In still another example, the apparatus may be directly coupled with an adjacent gear cutting machine via a transport device. In still another example, the apparatus may be arranged inside a toothed workpiece for chamfering internal toothings and the apparatus may further comprise an automatic tool changer.

It will be appreciated that FIGS. 1-6 are drawn approximately to scale. However, other dimensional relations may be used.

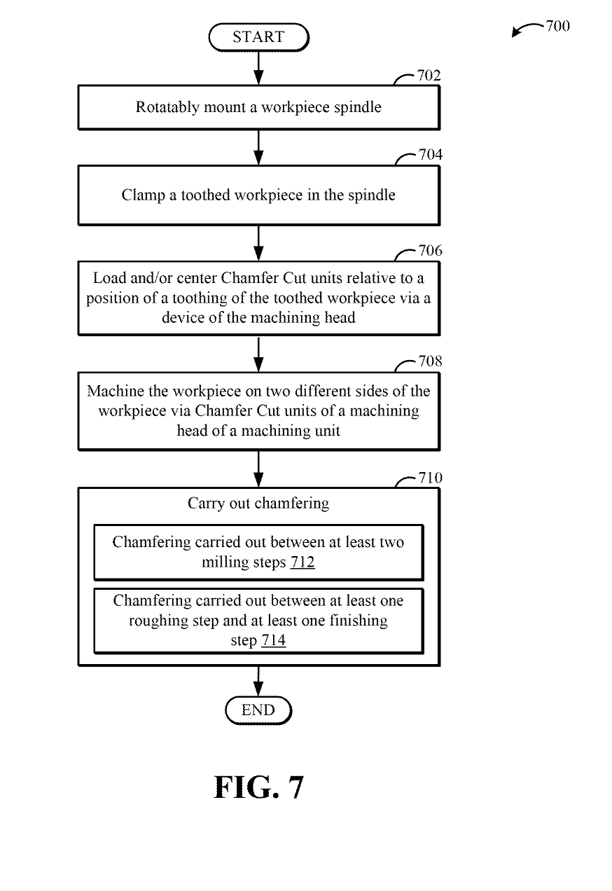

FIG. 7 depicts an example method 700 for chamfering a workpiece using the apparatus of FIGS. 1-6 having Chamfer Cut units.

At 702, the method includes rotatably mounting a workpiece spindle. The workpiece spindle may be rotatably mounted as shown in FIG. 1. At 704, the method includes clamping a toothed workpiece in the workpiece spindle. The toothed workpiece may be directly clamped to the workpiece spindle such that they are coupled with nothing in between. At 706, the method includes loading and/or centering Chamfer Cut units of a machining head of a machining unit relative to a position of a toothing of the toothed workpiece via a device of the machining head.

At 708, the method includes machining the workpiece on two different sides of the workpiece via the Chamfer Cut units. The machining may be performed via the Chamfer Cut units such that the Chamfer Cut units are directly coupled to the workpiece with no other components in between.

At 710, chamfering is carried out. In one example, the chamfering is carried out between at least two milling steps (at 712). In another example, the chamfering is carried out between at least one roughing step and at least one finishing step (at 714). One of the at last two milling steps may include, for example, a roughing step.

1. An apparatus for chamfering a toothed workpiece, comprising:
at least one rotatably mounted workpiece spindle; and
at least one machining unit with at least one machining head for chamfering the workpiece clamped in a spindle, wherein
the machining unit with at least one machining head comprises Chamfer Cut units which permit machining of the workpiece on two different sides of the workpiece, and wherein the machining unit with at least one machining head further comprises a device for loading and/or for centering the Chamfer Cut units relative to a position of a toothing on the toothed workpiece.

2. The apparatus according to claim 1, wherein the machining unit with at least one machining head comprises at least two separately actuatable Chamfer Cut units, provided on separately actuatable drives.

3. The apparatus according to claim 1, wherein the apparatus is arranged in a suspended position.

4. The apparatus according to claim 1, wherein the apparatus is arranged inside a gear cutting machine.

5. The apparatus according to claim 1, wherein the apparatus is formed as an independent chamfering machine.

6. The apparatus according to claim 1, wherein the apparatus is coupled with an adjacent gear cutting machine via a transport device.

7. The apparatus according to claim 1, wherein the apparatus is arranged inside a toothed workpiece for chamfering internal toothings and wherein the apparatus further comprises an automatic tool changer.

8. The apparatus of claim 1, wherein the machining unit is not in a vertical arrangement.

9. The apparatus of claim 1, wherein the Chamfer Cut units are rotatably mounted directly on the machining unit.

10. A method for chamfering a workpiece, comprising:
rotatably mounting a workpiece spindle;
clamping a toothed workpiece in the spindle;
loading and/or centering Chamfer Cut units of a machining head of a machining unit relative to a position of a toothing of the toothed workpiece via a device of the machining head; and
machining the workpiece on two different sides of the workpiece via the Chamfer Cut units.

11. The method according to claim 10, wherein the chamfering is carried out between at least two milling steps.

12. The method of claim 10, wherein the chamfering is carried out between at least one roughing step and at least one finishing step.

13. The method of claim 11, wherein one of the at least two milling steps includes a roughing step.

14. The method of claim 10, wherein machining the workpiece on two different sides includes machining the workpiece on two different sides at the same time via the Chamfer Cut units.
